(19) United States
(12) Patent Application Publication
(10) Pub. No.: US 2024/0420233 A1
(43) Pub. Date: Dec. 19, 2024

(54) SPORTS TRADING SYSTEM AND METHOD

(71) Applicant: SPORTS FUTURES XCHANGE PTY LTD, Forestville (AU)

(72) Inventors: Rhett Dinsdale, Forestville (AU); Leigh Mathew Taylforth, Forestville (AU)

(21) Appl. No.: 18/700,166

(22) PCT Filed: Oct. 11, 2022
(86) PCT No.: PCT/AU2022/051217

§ 371 Date: Apr. 10, 2024

(30) Foreign Application Priority Data
Oct. 12, 2021 (AU) 2021903280

(51) Int. Cl. G06Q 40/04; G06Q 30/0201; G06Q 50/34

(52) U.S. Cl. CPC G06Q 40/04; G06Q 30/0206; G06Q 50/34

(57) ABSTRACT

Disclosed herein is a system for sports trading. The system may comprise a processor and memory storing instructions that, when executed by the processor, cause the system to: generate a sports trading index. The sports trading index may be generated by retrieving from a sports data system via a data network information relating to a sporting event. The system may generate scoring information for each of a plurality of players in the sporting event, and generate by a digital sports asset exchange module a digital sports asset exchange. The system may communicate, via the data network, the generated sports trading index and digital sports asset exchange to a digital sports market module that is configured to match orders and offers to facilitate sports trading for the plurality of participants.

### TECHNICAL FIELD

Disclosed herein is a sports trading system. The system may be configured to generate a sports trading index and a digital sports asset exchange. The system may communicate the generated sports trading index and digital sports asset exchange to a digital sports market module, and match orders and offers to facilitate sports trading for a plurality of participants.

### BACKGROUND ART

Currently there is no way in sports trading for all market participants to openly and fairly mitigate risk with continuously traded instruments. At present, sports trading is divided into bookmakers and customers, with little thought given to other business participants (e.g. team ownership, agents, athletes, insurers & sponsors) or growing the market as a whole (e.g. by introducing institutions, brokerages, research houses). Bookmakers control betting markets, resulting in exceptionally wide markets catering to predominantly one sided betting. This presents several commercial problems with sports trading, including that it means bookmakers alone may control important free market principles such as price, spread and volume discovery and also results in marketing gimmicks such as bonus bets and early paybacks (on very limited bet sizes) at the expense of pricing transparency.

There are also several technical problems associated with the current sports trading and racing markets. For example, there is currently no system to monitor how much risk is flowing through the sports betting and management ecosystem. Further, there is no central body to regulate and monitor participants fairly, and no technology to monitor and prosecute malicious market activity. This is all handled privately by gaming operators and failing that, at a government level if laws are blatantly broken. Also, sporting wager events are, according to bookmaker offerings, binary outcome events, teams either win or lose, they either cover a scoring spread or don't. Individual players either hit a target number of attributes or they don't. Technical improvements are required for the sports trading market that address one or more of the above technical problems.

In this specification, unless the contrary is expressly stated, where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

### SUMMARY

As described above, sporting wager events are, according to bookmaker offerings, binary outcome events. Given these closed end outcomes, it is inherently difficult for related parties to use currently offered betting markets as a hedging tool, as are league and legal associations with teams “betting” to mitigate risk. For example, history is littered with examples of team officials, players etc betting against themselves and being banned as a result.

The Applicant has determined that the sports trading market is able be re-designed to correspond with financial markets. This is a fundamental shift in the way that sports trading is currently considered, and with appropriate technical implementation, is able to address the commercial and technical problems described above. This is because sporting events are continuous events without predetermined outcomes. As a game, week or season progresses, players and teams accumulate statistical tallies. These points tallies, with the use of a computer system (as will be described below), can be turned into an index of underlying performance from which a futures derivative contract may be based. These contracts give users the ability to hedge or speculate on their views and risks far more effectively than traditional binary trading products. Currently no mechanism or system exists for fans of fantasy sports, and sports fans in general, to track live value accretion and decline of their favourite teams and players continuously for financial benefit and risk. The system and method described below provides a fair and transparent marketplace and ecosystem for sporting and racing contracts to be traded by all interested parties.

Disclosed herein is a system for sports trading. The system may comprise a processor; and memory storing instructions that, when executed by the processor, cause the system to: generate by an index module a sports trading index by: retrieving from a sports data system via a data network first information relating to a sporting event, the first information comprising: an identifier of a plurality of players in the sporting event; and event information for each of the plurality of players in the sporting event, the event information comprising a statistic for a plurality of events; generating scoring information for each of the plurality of players in the sporting event by: applying a multiplying factor to the statistic for the plurality of events to generate a plurality of scores for each of the plurality of players in the sporting event; and summing the plurality of scores for each of the plurality of players in the sporting event to generate the sports trading index; generate by a digital sports asset exchange module a digital sports asset exchange by: retrieving from a futures contract system via data network at least one futures contract length for each of the plurality of players in the sporting event; determining an expected price for each of the plurality of players in the sporting event, the expected price being calculated by determining an expected value at a conclusion of the futures contract length; and determining optional prices that are above and below the expected price for each of the plurality of players in the sporting event; and communicate, via the data network, the generated sports trading index and digital sports asset exchange to a digital sports market module, the digital sports market module being configured to: output via the data network the generated sports trading index and digital asset exchange to a plurality of participants; receive via the data network a plurality of orders from the plurality of participants for one or more of the optional prices that are above and below the expected price for each of the plurality of players in the sporting event; receive via the data network a plurality of offers from the plurality of participants for one or more of the optional prices that are above and below the expected price for each of the plurality of players in the sporting event; sum the plurality of orders and offers and output via the data network the summed orders and offers with the optional prices that are above and below the expected price for each of the plurality of players in the sporting event; and match orders and offers to facilitate sports trading for the plurality of participants.

In some forms, the first information relating to the sporting event is retrieved continuously throughout the sporting event.

In some forms, the sports trading index is generated continuously throughout the sporting event using the first information.

In some forms, the digital market module continuously displays the continuously generated sports trading index throughout the sporting event.

In some forms, the sporting event comprises a portion of a game, a full game, or a plurality of games, wherein a duration of the sporting event corresponds with the futures contract length.

In some forms, orders and offers are able to be received continuously throughout the sporting event.

In some forms, the digital sports market module comprises a matching engine configured to match orders and offers to facilitate sports trading for the participants.

In some forms, the matching engine generates a futures contract upon matching of the offer with the order.

In some forms, the digital sports market module comprises a settlement module configured to enable an exchange of the futures contract between participants upon matching of the offer with the order, and for settling trading by the participants at a completion of the futures contract length.

In some forms, the identifier of the plurality of players in the sporting event comprises the name of each of the plurality of players.

In some forms, the statistic for a plurality of events comprises the number of times that the player has performed each of the plurality of events during the sporting event.

In some forms, the memory stores instructions that, when executed by the processor, cause the system to: retrieve rules for a sport associated with the sporting event, the rules comprising the multiplying factor for each of the plurality of events in the sporting event.

Also disclosed herein is a computer-implemented method for sports trading comprising; generating, by an index module, a sports trading index by: retrieving from a sports data system via a data network first information relating to a sporting event, the first information comprising: an identifier of a plurality of players in the sporting event; and event information for each of the plurality of players in the sporting event, the event information comprising a statistic for a plurality of events; generating scoring information for each of the plurality of players in the sporting event by: applying a multiplying factor to the statistic for the plurality of events to generate a plurality of scores for each of the plurality of players in the sporting event; and summing the plurality of scores for each of the plurality of players in the sporting event to generate the sports trading index; generating, by a digital sports asset exchange module, a digital sports asset exchange by: retrieving from a futures contract system via data network at least one futures contract length for each of the plurality of players in the sporting event; determining an expected price for each of the plurality of players in the sporting event, the expected price being calculated by determining an expected value at a conclusion of the futures contract length; and determining optional prices that are above and below the expected price for each of the plurality of players in the sporting event; and communicating, via the data network, the generated sports trading index and digital sports asset exchange to a digital sports market module, the digital sports market module being configured to: output via the data network the generated sports trading index and digital asset exchange to a plurality of participants; receive via the data network a plurality of orders from the plurality of participants for one or more of the optional prices that are above and below the expected price for each of the plurality of players in the sporting event; receive via the data network a plurality of offers from the plurality of participants for one or more of the optional prices that are above and below the expected price for each of the plurality of players in the sporting event; sum the plurality of orders and offers and output via the data network the summed orders and offers with the optional prices that are above and below the expected price for each of the plurality of players in the sporting event; and match orders and offers to facilitate sports trading for the plurality of participants.

### BRIEF DESCRIPTION OF DRAWINGS

Various embodiments/aspects of the disclosure will now be described with reference to the following figures.

FIG. 1 shows a schematic of the sports trading system;

FIG. 2 shows an example of the output of the sports trading system;

FIG. 3 shows example futures contracts;

FIG. 4 shows another schematic of the sports trading system shown in FIG. 1;

FIG. 5 shows a schematic of a portion of the sports trading system shown in FIG. 4;

FIG. 6 shows another schematic of a portion of the sports trading system shown in FIG. 4; and

FIG. 7 shows another schematic of a portion of the sports trading system shown in FIG. 4.

### DETAILED DESCRIPTION

Disclosed herein is computer system that uses a statistical events based points system to create a tradeable index on which futures and options may be listed. This is an innovative approach to trading in the global sports betting industry, and addresses the aforementioned technical and commercial problems with the current industry.

A statistical index value may be created by assigning points values (and multipliers and bonus/penalty additions) to live game events. The index products described below implement a computer system to calculate and publish live index points values that can be used to derive the aforementioned securities fair value as expiry approaches. The system described below allows participants to enter, modify and trade/match orders on a variety of statistical instruments particular to each sporting market. These instruments may range in complexity from simple attribution statistics (e.g. number of wins at the end of the week/month/season), to more complex index products.

The exchange trading and technology solution described herein is at the forefront of innovation in a stale industry dominated by strict regulation and outdated market composition and approach. As sports betting markets continue to deregulate, and major leagues keep partnering with sports betting providers, the system described herein may offer the only fair, fully open (to all participants and regulators), continuously priced, exchange trading solution. The system described herein may add revenue lines to existing bookmakers and open up a whole new field of risk management for sporting industry companies and participants.

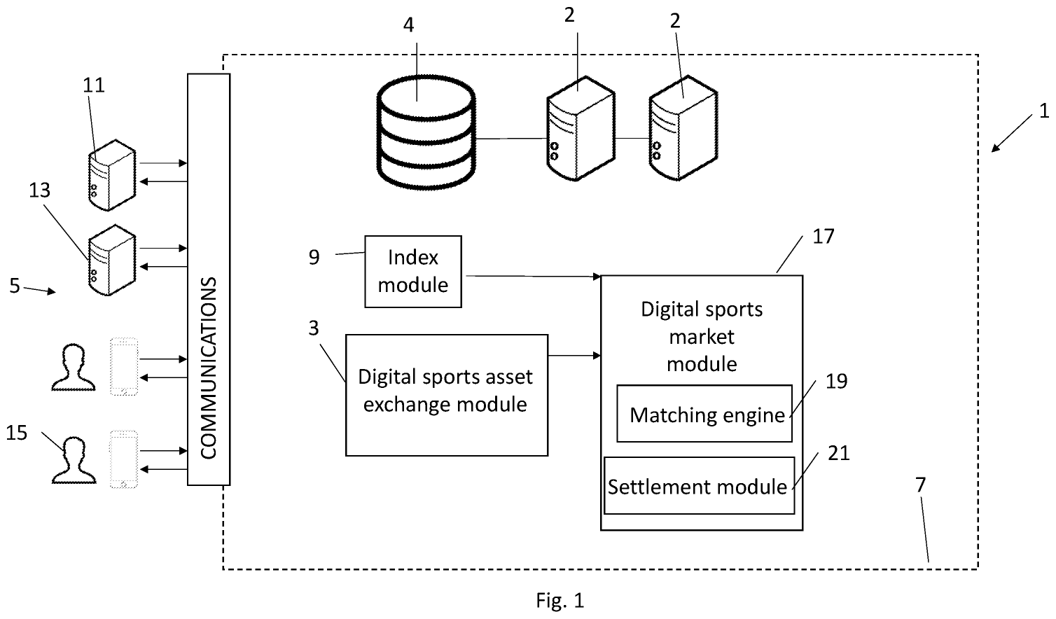

Referring firstly to FIG. 1, a data management system 1 implemented using a processor 2 (the term processor refers to one or more processors) and memory resources 4 accessible by third party systems 5 (e.g. participants, data supply systems, etc) via a data network 7 is shown. The third party systems 5 are in the form of a processing device (e.g. a PC, tablet, smartphone, etc.) that enables third parties to access the system 1.

The system includes an index module 9 that is configured to generate a sports trading index. The index module 9 generates the sports trading index by retrieving from a sports data system 11 via a data network 7 first information relating to a sporting event. The sporting event may be a portion of a game, a full game, several games, a season, etc. The first information includes an identifier (e.g. a name) of a plurality of players in the sporting event, and event information for each of the plurality of players in the sporting event. The event information includes a statistic for a plurality of events. As an example, for an Australian Football League (AFL) player, the events may include tackles, kicks, marks, goals, clangers, etc. For a baseball player, the events may include events that relate to hitters (e.g. runs, walks, stolen base, hit by pitcher, caught stealing etc) and fielders (e.g. put out, assisted out, errors, etc). The statistics received relates to the number of times that each player has performed the associated events. The first information is received continuously throughout the sporting event such that it can be continuously used by the sports trading system 1.

Scoring information is generated for each of the plurality of players in the sporting event. The scoring information is generated by applying a multiplying factor to the statistic for the plurality of events to generate a plurality of scores for each of the plurality of players in the sporting event. For example, for AFL, a kick may be ascribed 3 points. As such, a multiplier of 3 will be applied to the statistic (e.g. a kick equates to 3 points after the multiplier is applied). Negative multipliers are able to be applied also. For example, for AFL, a clanger may be ascribed −4 points. As such, a multiplier of −4 is applied to the statistic.

The plurality of scores for each of the plurality of players in the sporting event are summed to generate the sports trading index. For example, at any point in time, each of the scores (as generated using the multipliers) for each player are added together such that a total accumulated score for each player is able to be determined.

The system also includes a digital sports asset exchange module 3 that is configured to generate a digital sports asset exchange. The digital sports asset exchange is generated by retrieving from a futures contract system 13 via data network 7 at least one futures contract length for each of the plurality of players in the sporting event. The futures contract system may form part of the sports trading system (e.g. may be held on a database that forms part of the system), or may be a separate system (e.g. may be held on a separate database that is accessible via the system). An expected price for each of the plurality of players in the sporting event is calculated. The expected price is calculated by determining an expected value at a conclusion of the futures contract length. For example, for an AFL player, the expected value may be the total number of points (calculated using the same methodology described above with respect to the index) that the player is expected to accumulate over the course of the sporting event (e.g. a season). The calculation may simply involve determining the total number of points that the player had accumulated over a similar length of time in a previous season. Optional prices that are above and below the expected price are also calculated for each of the plurality of players in the sporting event. For example, optional prices may be determined by simply adding or subtracting incremental values (e.g. increments increasing and decreasing by 0.25) to the expected price.

The generated sports trading index and digital sports asset exchange are then communicated via the data network to a digital sports market module 17. The digital sports market module 11 is configured to output via the data network the generated sports trading index and digital asset exchange to a plurality of participants 15. This enables participants to view the generated index and exchange on, for example, a smartphone. The digital sports market module 11 is also configured to receive via the data network 7 a plurality of orders from the plurality of participants for one or more of the optional prices that are above and below the expected price for each of the plurality of players in the sporting event. The orders may be referred to as ‘bids’, where participants enter via the a device that is able to communicate with the data network 7 bids that correspond with an optional price (e.g. an increment of 0.25, 0.5, 0.75, 1, etc above or below the expected price displayed to the participant).

The digital sports market module 11 is also configured to receive via the data network 7 a plurality of offers from the plurality of participants for one or more of the optional prices that are above and below the expected price for each of the plurality of players in the sporting event. The offers may be entered via the a device that is able to communicate with the data network 7 prices that correspond with an optional price (e.g. an increment of 0.25, 0.5, 0.75, 1, etc above or below the expected price displayed to the participant). The module 17 is configured to sum the plurality of orders and offers and output via the data network the summed orders and offers with the optional prices that are above and below the expected price for each of the plurality of players in the sporting event.

The module 17 is further configured to match orders and offers to facilitate sports trading for the plurality of participants. The digital sports market module comprises a matching engine 19 configured to match the orders and offers to facilitate sports trading for the participants. The matching engine generates a futures contract upon matching of the offer with the order.

Orders (bids) and offers are able to be received continuously throughout the sporting event (e.g. throughout the futures contract length) to enable participants to continuously engage with the sports trading system during a sporting event. For example, participants may place bids and offers for several players on several occasions throughout a sporting event.

The digital sports market module 17 comprises a settlement module 21 configured to enable an exchange of the futures contract between participants upon matching of the offer with the order, and for settling trading by the participants at a completion of the futures contract length.

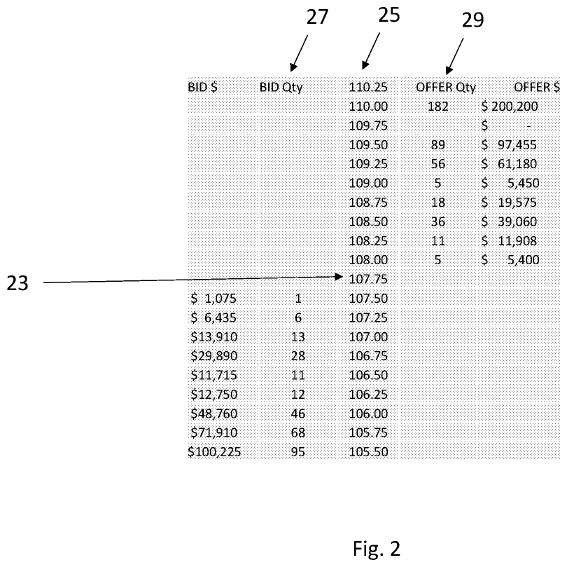

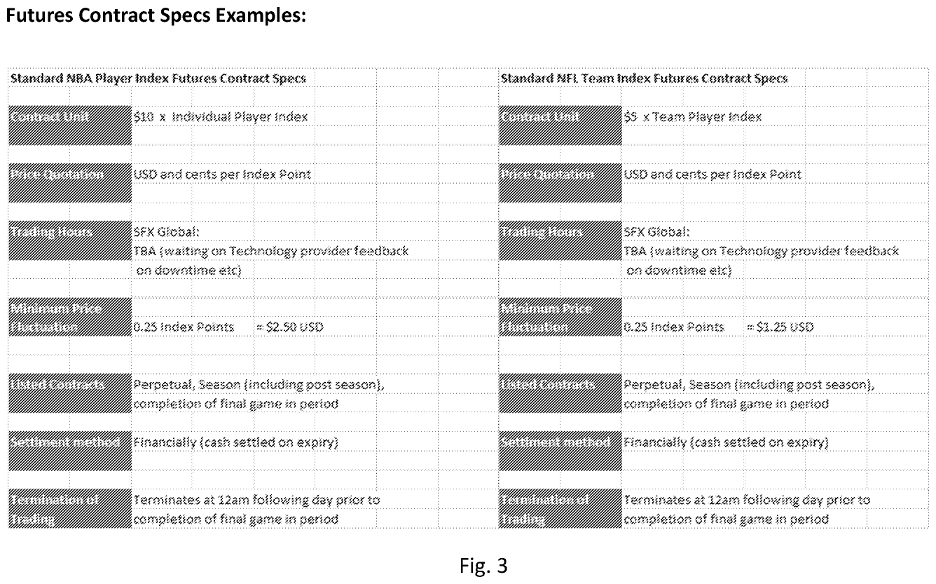

FIG. 2 shows example data (in the form of a table) generated by the digital sports market module 17. FIG. 2 shows the expected price 23 (107.75) for LeBron James (NBA) at the completion of a theoretical contract. The middle row in the table shows the optional pricing 25 (increments of 0.25 from the expected price). The second and fourth rows show the summed number of bids 27 and offers 29 for each optional price, as entered by participants. The first and fifth rows show the accumulated value for each of the summed bids and offers. FIG. 3 shows examples of future contracts for NBA players 31 and NFL players 33.

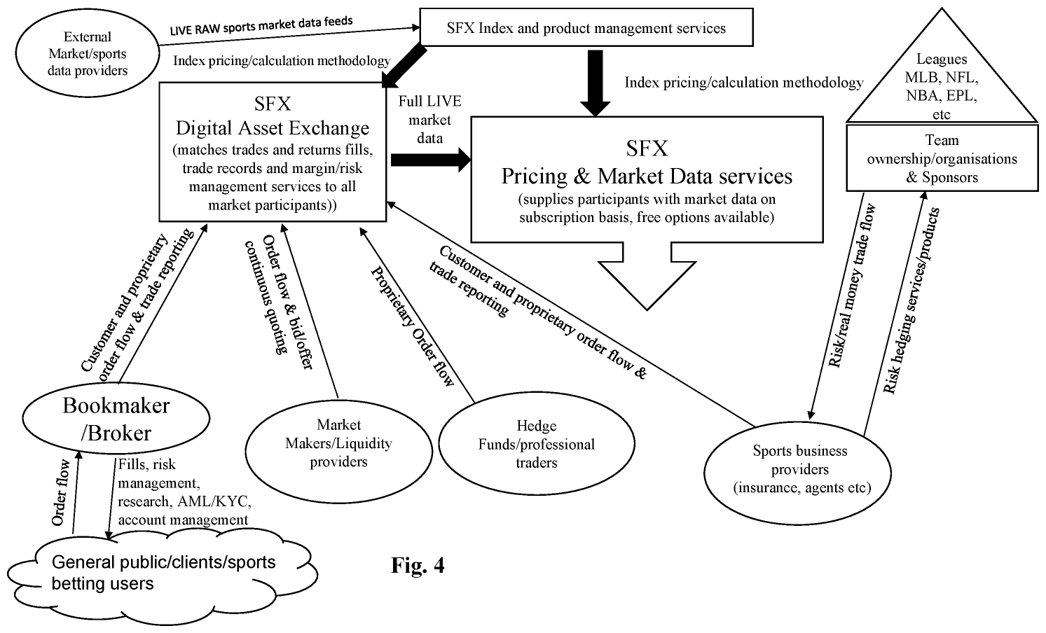

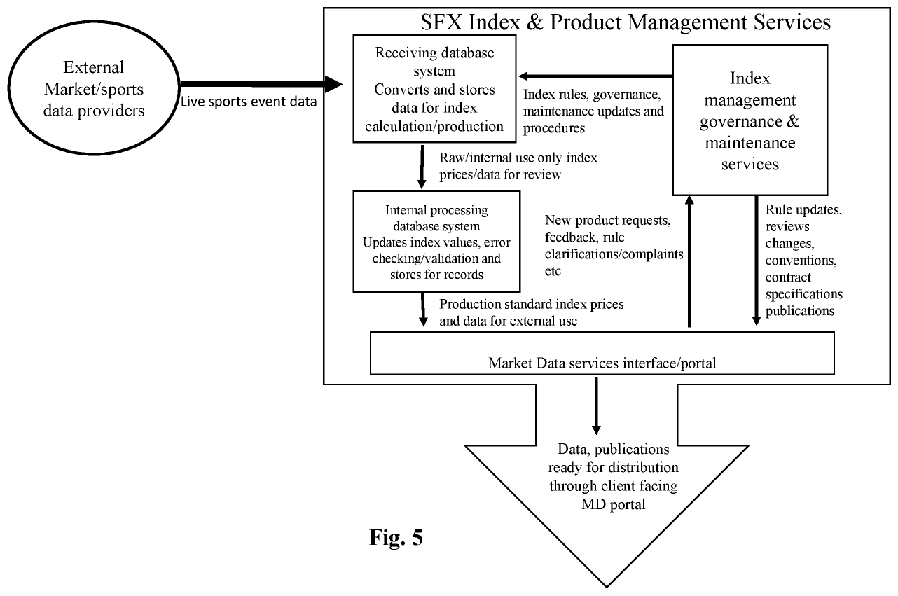

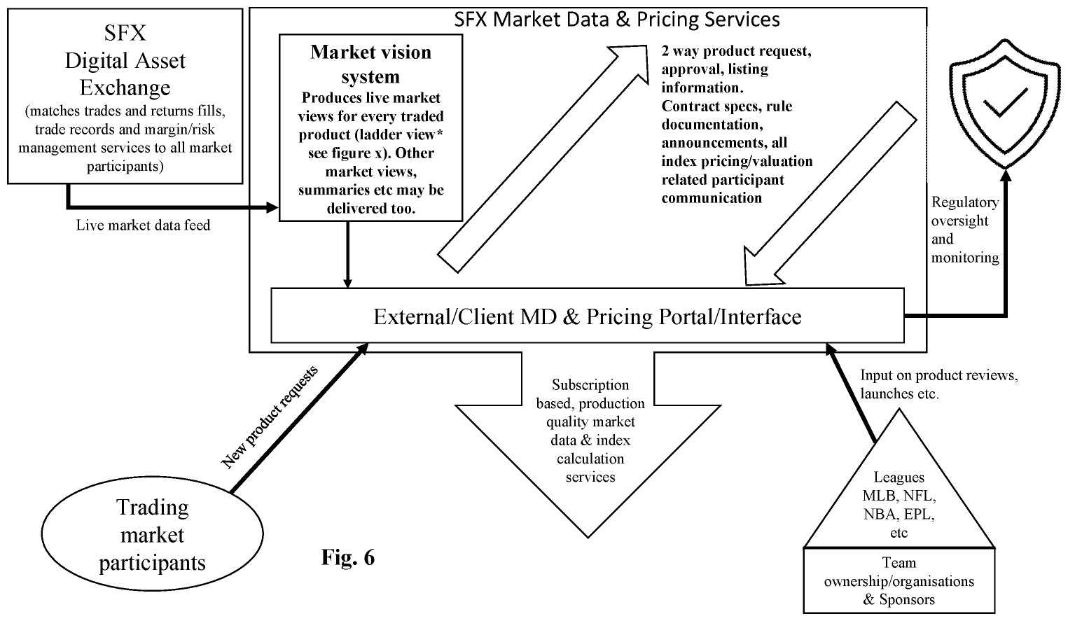

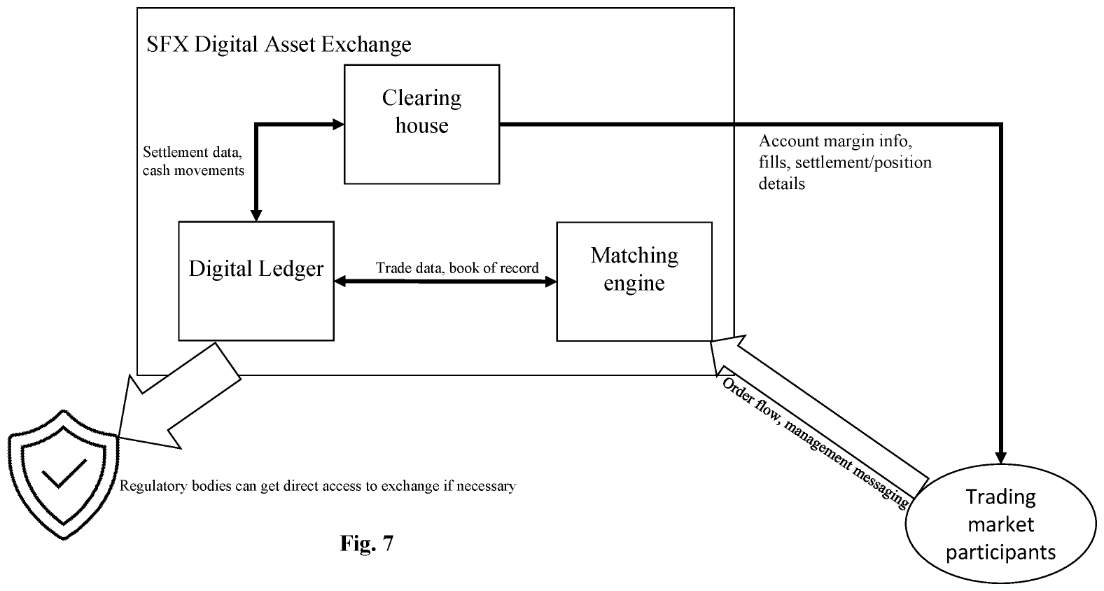

The system and method described above will now be described in further detail with respect to FIGS. 4 to 7. This description serves as a general guide to managing the Sports Futures Exchange (SFX) family of player, team and league indexes.

The SFX family of player and team & individual player indexes may accumulate points in accordance with the Sports Specific Statistical Accumulation Record (SSSAR) for each individual sport available to trade on the SFX exchange. In one embodiment, the system will maintain these records for individual sports electronically, updating and changing in accordance with the index guidance set by an advisory committee.

### Sports Specific

Each sport covered in the SFX Index family is uniquely different and as such will have a unique SSSAR for points attribution and accumulation. Team and individual player indexes will also maintain separate SSSARs so that, in many cases, individual players will accumulate points at differing rates to their teams.

### Calculation of Continuous Accumulation Metrics

In one embodiment, the system may utilise advanced live stream connectivity technology, frequently used in traded financial markets, to receive in-game play-by-play statistical data, which will then be cross referenced with the sport's team and individual current official SSSAR.

Points will be attributed to teams and individuals and accumulate as statistical events play out and according to official league rulings. These points will form a total value which will be the official SFX Index value at that point in time. This points value may be used to trade futures on the SFX Exchange as a measure of a contract's “fair value” since it will be this points total/value that a futures contract expiry/settlement value will be set.

In general it's simple to think of this accumulation methodology as functioning like a Fantasy sports points system. The exception being that the indexes are continuously accumulating until their specific set expiry condition is met.

### Player Index Divisor Use and Calculations:

In some forms, Player Indexes may need to be reduced to a common base to allow for equal, in percentage terms, points value accretion and decreasing. A divisor isn't required at the team level because for a normal season to run to completion all teams must have an equal opportunity to participate, as per individual league rules. Whereas players are subject to injury, coaching decisions etc which impacts their opportunity to accumulate points. Individual sports will vary and exact details will be set out in each sport's index methodology document, but in general the system will use ‘opportunities’ as a divisor for individual player indexes. For NBA player indexes each players index value may be calculated as follows:

Index FV=Total accumulated points (+/−bonus)/OPPORTUNITIES

### Opening/Expiry Day Calculations

An index's points value will generally open at the current accumulated points value, or “fair value” during the first few seconds of the first game being played on, or closest after the opening day for that contract. For example a weekly index will open at current fair value (generally equal to previous expiry value from the week before, just finished) during the first few seconds of the first game played on or after Sunday. A monthly index may open at current fair value (generally equal to previous expiry value from the month before, just finished) during the first few seconds of the first game played on or after the first of the new month.

Some index values may be reset to depending on the contract traded and participant requests. For example weekly only and monthly only indexes may always open the new period at 0 points value with no carry over from the previous period.

### Closing/Expiry Day:

An index may cease to accumulate points following the completion (officially) of the last game in the index period. The points total at this time shall be the official expiry value for settlement and expiring futures contracts. The system may sometimes need to adjust this value based on official rulings, provisions are made for this in the index review section earlier in this document. For example an NFL Team Monthly Index may expire/close at the points value at the completion of the final scheduled game in the calendar month.

### Bonus/Penalty Awards and Multipliers

### Sport Specific

The system may include provisions for teams and player indexes to accumulate bonus points and also negative penalties based on milestone events, league titles etc all specific to individual sporting leagues. The system may also use multipliers in certain in game scenarios to boost or slow points accumulation depending on the live situation. Details for individual indexes and sporting leagues can be found in each leagues official methodology documents and SSSARs.

### League Titles Events

The system may have reserved provisions for indexes to use bonus and penalty based event based points accumulation. Team and player indexes will have the ability to gain or lose points, based on season, title, or some other milestone event. These points may accumulate in a single block at completion (with confirmation) of the individual milestone event. For example an NFL player contract may receive 25 bonus points to their index value for being the touchdown leader for that month. For example a MLB baseball player may receive a 25 point penalty for having the most strikeouts, as a hitter for the month. In both cases above the points may be awarded immediately upon confirmation of the award/penalty.

### In Game Situational

The system may have reserved provisions for indexes to accumulate points at a faster or slower rate according to in-game, situational multipliers. For example an NBA player may accumulate points at a rate of 1.5× the normal points value per statistical event in playoff games, or overtime periods. These multipliers will be listed, recorded and updated in individual SSSARs and bound by the same review process as the rest of the points accumulation metrics.

### Client Produced Index Policy & Procedures

The system may be configured to frequently liaise with market participants and may be able to manage any customer/participant created indexes. The system may manage these indexes under the same guidelines and general methodology as the pre-set family of indexes, allowing of course for individual methodology. Participants may request a new index product creation and listing via a market data and pricing services portal. The request may then go before the system for review and an advisory committee for input on practicality and management concerns. Once approved and created the new indexes may be available on the system, depending on subscription privileges, to the market for pricing and trading (if listed as well)

As will be evident to the skilled addressee, the above described system and method may be applied to something other than players. For example, it may be applied to sports teams with appropriate adjustments (e.g. statistics such as wins and losses).

The word ‘comprising’ and forms of the word ‘comprising’ as used in this description and in the claims does not limit the invention claimed to exclude any variants or additions.

Modifications and improvements to the invention will be readily apparent to those skilled in the art. Such modifications and improvements are intended to be within the scope of this invention.

1. A system for sports trading comprising;
a processor; and
memory storing instructions that, when executed by the processor, cause the system to:
generate by an index module a sports trading index by:
retrieving from a sports data system via a data network first information relating to a sporting event, the first information comprising:
an identifier of a plurality of players in the sporting event; and
event information for each of the plurality of players in the sporting event, the event information comprising a statistic for a plurality of events;
generating scoring information for each of the plurality of players in the sporting event by:
applying a multiplying factor to the statistic for the plurality of events to generate a plurality of scores for each of the plurality of players in the sporting event; and
summing the plurality of scores for each of the plurality of players in the sporting event to generate the sports trading index;
generate by a digital sports asset exchange module a digital sports asset exchange by:
retrieving from a futures contract system via data network at least one futures contract length for each of the plurality of players in the sporting event;
determining an expected price for each of the plurality of players in the sporting event, the expected price being calculated by determining an expected value at a conclusion of the futures contract length; and
determining optional prices that are above and below the expected price for each of the plurality of players in the sporting event; and
communicate, via the data network, the generated sports trading index and digital sports asset exchange to a digital sports market module, the digital sports market module being configured to:
output via the data network the generated sports trading index and digital asset exchange to a plurality of participants;
receive via the data network a plurality of orders from the plurality of participants for one or more of the optional prices that are above and below the expected price for each of the plurality of players in the sporting event;
receive via the data network a plurality of offers from the plurality of participants for one or more of the optional prices that are above and below the expected price for each of the plurality of players in the sporting event;
sum the plurality of orders and offers and output via the data network the summed orders and offers with the optional prices that are above and below the expected price for each of the plurality of players in the sporting event; and
match orders and offers to facilitate sports trading for the plurality of participants.

2. The system for sports trading according to claim 1, wherein the first information relating to the sporting event is retrieved continuously throughout the sporting event.

3. The system for sports trading according to claim 2, wherein the sports trading index is generated continuously throughout the sporting event using the first information.

4. The system for sports trading according to claim 3, wherein the digital market module continuously displays the continuously generated sports trading index throughout the sporting event.

5. The system for sports trading according to claim 1, wherein the sporting event comprises a portion of a game, a full game, or a plurality of games, wherein a duration of the sporting event corresponds with the futures contract length.

6. The system for sports trading according to claim 1, wherein orders and offers are able to be received continuously throughout the sporting event.

7. The system for sports trading according to claim 1, wherein the digital sports market module comprises a matching engine configured to match orders and offers to facilitate sports trading for the participants.

8. The system for sports trading according to claim 7, wherein the matching engine generates a futures contract upon matching of the offer with the order.

9. The system for sports trading according to claim 8, wherein the digital sports market module comprises a settlement module configured to enable an exchange of the futures contract between participants upon matching of the offer with the order, and for settling trading by the participants at a completion of the futures contract length.

10. The system for sports trading according to claim 1, wherein the identifier of the plurality of players in the sporting event comprises the name of each of the plurality of players.

11. The system for sports trading according to claim 1, wherein the statistic for a plurality of events comprises the number of times that the player has performed each of the plurality of events during the sporting event.

12. The system for sports trading according to claim 1, wherein the memory stores instructions that, when executed by the processor, cause the system to: retrieve rules for a sport associated with the sporting event, the rules comprising the multiplying factor for each of the plurality of events in the sporting event.

13. A computer-implemented method for sports trading comprising;
generating, by an index module, a sports trading index by:
retrieving from a sports data system via a data network first information relating to a sporting event, the first information comprising:
an identifier of a plurality of players in the sporting event; and
event information for each of the plurality of players in the sporting event, the event information comprising a statistic for a plurality of events;
generating scoring information for each of the plurality of players in the sporting event by:
applying a multiplying factor to the statistic for the plurality of events to generate a plurality of scores for each of the plurality of players in the sporting event; and
summing the plurality of scores for each of the plurality of players in the sporting event to generate the sports trading index;
generating, by a digital sports asset exchange module, a digital sports asset exchange by:
retrieving from a futures contract system via data network at least one futures contract length for each of the plurality of players in the sporting event;
determining an expected price for each of the plurality of players in the sporting event, the expected price being calculated by determining an expected value at a conclusion of the futures contract length; and
determining optional prices that are above and below the expected price for each of the plurality of players in the sporting event; and
communicating, via the data network, the generated sports trading index and digital sports asset exchange to a digital sports market module, the digital sports market module being configured to:
output via the data network the generated sports trading index and digital asset exchange to a plurality of participants;
receive via the data network a plurality of orders from the plurality of participants for one or more of the optional prices that are above and below the expected price for each of the plurality of players in the sporting event;
receive via the data network a plurality of offers from the plurality of participants for one or more of the optional prices that are above and below the expected price for each of the plurality of players in the sporting event;
sum the plurality of orders and offers and output via the data network the summed orders and offers with the optional prices that are above and below the expected price for each of the plurality of players in the sporting event; and
match orders and offers to facilitate sports trading for the plurality of participants.
